(19) United States
(12) Patent Application Publication
(10) Pub. No.: US 2026/0024039 A1
(43) Pub. Date: Jan. 22, 2026

(54) Industry development state assessment device and apparatus based on dissipative structural model

(71) Applicant: Institute of Science and Development, Chinese Academy of Sciences, Beijing (CN)

(72) Inventors: Jianfeng Guo, Beijing (CN); Jiayi Zhou, Beijing (CN); Qi Cao, Beijing (CN); Siyao Liu, Beijing (CN); Jiaofeng Pan, Beijing (CN)

(21) Appl. No.: 19/346,554

(22) Filed: Sep. 30, 2025

(51) Int. Cl. G06Q 10/067; G06F 17/13

(52) U.S. Cl. CPC G06Q 10/0674; G06F 17/13

(57) ABSTRACT

An industry development state assessment device includes: an industry data acquisition module for acquiring time-series-based industry data of different industries; a dissipative structure model definition module for mapping a nonlinear mutual feedback relationship between industry development core elements, and for obtaining a dissipative structure state function of industry development; an industry development state value calculation module for sequentially substituting the time-series-based industry data of the different industries into the dissipative structure state function to obtain time-series-based data of industry development states of the different industries; and an assessment module for clustering the time-series-based data of the industry development states of the different industries to obtain at least one industry collection with similar evolutionary laws. The device can quantitatively describe the stability of the industry development process and improve the accuracy and reliability of the industry development assessment.

### BACKGROUND OF THE PRESENT INVENTION

### Field of Invention

The present invention relates to the technical field of computing, and more particularly to an industry development state assessment device and apparatus based on a dissipative structural model.

### Description of Related Arts

Industries exhibit significant heterogeneity in their structural characteristics, development trajectories, innovation capabilities, and market environments. This diversity complicates the analysis of their evolutionary patterns and stability status, leading to varied dynamic performances in resource allocation, technological innovation, and market adaptability. A comprehensive evaluation of the development state of different industries provides a theoretical framework for assessing the evolution status and dynamics of the industrial system, as well as technological support for evaluating the development potential of a specific industry. Although conventional frameworks for industry assessment exist, including but not limited to SWOT, Porter's Five Forces, PEST, and Life Cycle analysis, they all have a critical deficiency that is overwhelmingly qualitative and subjective in nature. The inherent limitations mean they fail to provide a precise, numerical measure of an industry's operational state. Consequently, these methods cannot reveal the underlying quantitative laws and internal dynamics that govern a system's transition between different development states.

Therefore, there is an urgent need to accurately and reliably design the device to establish an industry development description framework and assess the state of industry development.

### SUMMARY OF THE PRESENT INVENTION

To address the deficiencies in conventional methods, an object of the present invention is to provide an industry development state assessment device and apparatus based on the Dissipative Structure Theory in complexity science, which enables a quantitative, accurate, and reliable assessment of the industry's development state.

Accordingly, in order to accomplish the above objects, the present invention provides a device for assessing the evolution status of an industry development cycle based on a dissipative structural model, comprising:
an industry data acquisition module for acquiring time-series data of different industries, wherein the industry data is derived from financial statements, including a balanced sheet, a profit and loss statement, a cash flow statement, and data points such as inventory, operating revenues, operating costs, selling expenses, administrative expenses, research and development (R&D) expenses, and financial expenses;
a dissipative structure model definition module for defining a dissipative structure state function by mapping the nonlinear, mutual feedback relationship between core elements of industry development, in accordance with the Brusselator model and empirical laws of industry development state;
an industry development state value calculation module for calculating a time series of dissipative structure state values of each industry by sequentially inputting the industry time-series data into the defined dissipative structure functions; and an assessment module to perform a comparative assessment by clustering the time series of state values to identify industry collections exhibiting similar evolutionary patterns, and then comparing and evaluating the industry evolutionary laws within the industry collections and between different collections.

Preferably, the industry data acquisition module comprises:
an initial data acquisition unit for acquiring industry initial data of the different industries at different time points; and
a data processing unit for interpolating, normalizing, and summarizing the industry initial data to obtain processed industry data.

Preferably, the dissipative structural model definition module comprises:
a Brusselator model construction unit for constructing a reaction equation of an industry system evolution based on the Brusselator model, wherein reaction elements of the reaction equation comprise reactants, products, intermediate products, and reaction catalysts;
a reaction element definition unit for determining a calculation formula for each of the reaction elements based on industry characteristics and characteristics of each of the reaction elements; and
a dissipative structure state function construction unit for constructing the dissipative structure state function by characterizing and solving the reaction equation of the industry system evolution according to chemical reaction kinetics.

Preferably, the reaction equation is expressed as:

$$A ( periodization depletion ) {\to }^{{k}_{1}} X ( orderly organization state of productive resources ) ;$$

$$B ( objectified depletion ) \text{} + X ( orderly organization state of productive resources ) {\to }^{{k}_{2}} D ( inventory ) + Y ( operating revenue ) ;$$

$$Y ( operating revenue ) \text{} + 2 \text{} X ( orderly organization state of productive resources ) {\to }^{{k}_{3}} 3 X ( industrial expansion ) ;$$

$$X ( orderly organization state of productive resources ) {\to }^{{k}_{4}} E ( waste of productive resources ) ;$$

wherein A and B are the reactants, D and E are the products, X and Y are the intermediate products, kᵢ is the reaction catalysts, k₁ denotes an information transfer efficiency, k₂ denotes a capital turnover rate, k₃ denotes a return on investment, and k₄ denotes a system waste rate.

Preferably, the periodization depletion is expressed as:

$$periodization depletion ( A ) = \frac{\begin{matrix}administrative expenses + research and development \\ expenses + selling expenses + financial expenses\end{matrix}}{total operating costs} ;$$

the objectified depletion is expressed as:

$$objectified depletion ( B ) = \frac{operating costs}{total operating costs} ;$$

the inventory level is expressed as:

$$inventory level ( D ) = \frac{inventory}{total operating costs} ;$$

the operating revenue level is expressed as:

$$operating revenue level ( Y ) = \frac{operating revenue}{total operating costs} ;$$

the information transfer efficiency is expressed as:

$$information transfer efficiency ( {k}_{1} ) = \frac{\begin{matrix}Current Period Operating Revenue / \\ Prior Period Operating Revenue\end{matrix}}{Current Period Depletion / Prior Period Depletion} ;$$

the capital turnover rate is expressed as:

$$capital turnover rate ( {k}_{2} ) = \frac{operating revenue}{current assets} ;$$

the return on investment is expressed as:

$$return on investment ( {k}_{3} ) = \frac{operating profit increment}{total operating costs} ;$$

the system waste rate is expressed as:

$$system waste rate ( {k}_{4} ) = \frac{\begin{matrix}inventory + administrative expenses + \\ financial expenses - net profit\end{matrix}}{periodization depletion + objectified depletion} .$$

Preferably, the dissipative structure state function is obtained as follows:
based on the chemical reaction kinetics, the intermediate products in the reaction equation of the industry system evolution are differentiated to obtain a differential equation set:

$$\{ \begin{matrix}\frac{dX}{dt} = {k}_{1} A - {k}_{2} BX + {k}_{3} {X}^{2} Y - {k}_{4} X \\ \frac{dX}{dt} = {k}_{2} BX + {k}_{3} {X}^{2} Y\end{matrix} ;$$

the differential equation set is then transformed to obtain a transformed equation set:

$$\{ \begin{matrix}\frac{dx}{d τ} = a - ( b + 1 ) x + {x}^{2} y \\ \frac{dy}{d τ} = bx - {x}^{2} y\end{matrix} ;$$

wherein

$$x = \sqrt{\frac{{k}_{3}}{{k}_{4}}} X , y = \sqrt{\frac{{k}_{3}}{{k}_{4}}} Y ;$$

$$a = \sqrt{\frac{{k}_{1}^{2} {k}_{3}}{{k}_{4}^{3}}} A , b = \frac{{k}_{2}}{{k}_{4}} B , τ = {k}_{4} t ;$$

then stability analysis is performed on the transformed equation set to determine a characteristic equation:

$${λ}^{2} + ( {a}^{2} + 1 - b ) λ + {a}^{2} = 0 ;$$

wherein λ is an eigenvalue;
the dissipative structure state function is determined based on a real part of the eigenvalue in combination with a stability equation:

$$IS = {k}_{2} {k}_{4}^{2} B - ( {k}_{4}^{3} + {k}_{1}^{2} {k}_{3} {A}^{2} ) ,$$

wherein IS is an industry's dissipative structure state value,
when IS is greater than zero, the industry development cycle is unstable, forming a dissipative structure;
when IS is equal to zero, the industry development cycle is at a critical juncture of being stable or unstable; and
when IS is less than zero, the industry development cycle is stable and non-dissipative.

Preferably, the assessment module comprises:
a standardization unit for standardizing the time-series-based data of the industry development states of the different industries, and obtaining a processed time-series-based data of the industry development states, which is:

$${t}_{i k}^{′} = \frac{{t}_{i k} - {\overline{t}}_{i}}{{σ}_{i}} , k = 1 , 2 , … , m ;$$

wherein t̅ᵢ is a mean value of a series Tᵢ, σᵢ is a standard deviation thereof, and

$${t}_{i k}^{′}$$

is a k-th point of a standard time series Tᵢ;
a clustering unit for utilizing a K-Shape clustering algorithm to classify the processed time-series-based data of the industry development states to obtain at least one industry collection with similar evolutionary laws; and an assessment unit for assessing the industry evolution states based on the
time-series-based data in each of the industry collection to determine an adjustment strategy for industry development.

Preferably, the clustering unit is configured to:
randomly select a plurality of the time-series-based data as initial group centers;
calculate similarities between each of the time-series-based data and each of the initial group centers, and assign each of the time-series-based data to one of the series groups in which the initial group center with the highest similarity is located; and
re-determine group centers of each of the series groups and re-assign the series groups based on the similarities until a convergence condition is satisfied, so as to obtain a plurality of target series groups; wherein each of the target series groups has at least one industry collection; the convergence condition is: the group centers of the series groups are no longer changed, or a pre-determined maximum number of iterations is reached.

Preferably, the similarities between each of the time-series-based data and each of the initial group centers are calculated as:

$$NCC ( {T}_{i} , {C}_{j} ) = {max}_{τ} \frac{{\sum }_{k = 1}^{m} {t}_{i k}^{′} \cdot {c}_{j ( k + τ )}^{′}}{\sqrt{{\sum }_{k = 1}^{m} {( {t}_{i k}^{′} )}^{2}} \cdot \sqrt{{\sum }_{k = 1}^{m} {( {c}_{j ( k + τ )}^{′} )}^{2}}} ;$$

wherein NCC(Tᵢ, Cⱼ) is a similarity between i-th time-series-based data and a j-th initial group center, τ is an offset,

$${t}_{i k}^{′}$$

is a k-th point of the i-th time-series-based data Tᵢ, and

$${c}_{j ( k + τ )}^{′}$$

is a k-th point of the j-th initial group center after offset processing.

The present invention further provides an assessment apparatus, comprising: a memory and a processor, wherein a computer program is stored on the memory and is runnable on the processor; wherein the assessment apparatus further comprises the industry development state assessment device as mentioned above.

With the foregoing structure, the industry development state assessment device and the apparatus based on the dissipative structure model are provided. The device comprises: an industry data acquisition module for acquiring time-series-based industry data of different industries, wherein the industry data comprise a balance sheet, a profit and loss statement, and a cash flow statement; the cash flow statement comprises inventory data, operating revenues, operating costs, selling expenses, administrative expenses, research and development expenses, and financial expenses; a dissipative structure model definition module for mapping a nonlinear mutual feedback relationship between industry development core elements according to a Brusselator model and an industry development cycle law, and for obtaining a dissipative structure state function of industry development cycles, wherein the dissipative structure state function is used to characterize development cycle states of the different industries at each time point; an industry development state value calculation module for sequentially substituting the time-series-based industry data of the different industries into the dissipative structure state function to obtain time-series-based data of industry development states of the different industries; and an assessment module for clustering the time-series-based data of the industry development states of the different industries to obtain at least two industry collections with similar evolutionary laws, and then comparing and evaluating the industry evolutionary laws of each of the industry collections. The device provided by the present invention can quantitatively describe the stability of the industry development process, thereby improving the accuracy and reliability of industry development assessments.

These and other objectives, features, and advantages of the present invention will become apparent from the following detailed description, the accompanying drawings, and the appended claims.

### BRIEF DESCRIPTION OF THE DRAWINGS

In order to more clearly illustrate the technical solutions in the embodiments or prior art herein, the accompanying drawings to be used in the description of the embodiments or prior art will be briefly introduced hereinafter. It will be evident that the accompanying drawings in the description hereinafter are only a part of all embodiments, and that other accompanying drawings may be obtained by a person of ordinary skill in the art without creative labor.

FIG. 1 is a framework of an industry development state assessment device based on a dissipative structural model according to an embodiment of the present invention;

FIG. 2 is a sketch view of an industry system according to the embodiment of the present invention;

FIG. 3 illustrates a system dissipative evolution state (stable node) according to the embodiment of the present invention;

FIG. 4 illustrates a system dissipative evolution state (unstable node) according to the embodiment of the present invention;

FIG. 5 illustrates a system dissipation evolution state (stable focus) according to the embodiment of the present invention;

FIG. 6 illustrates a system dissipation evolution state (unstable focus) according to the embodiment of the present invention; and

FIG. 7 is a framework of a computer device according to the embodiment of the present invention.

### DETAILED DESCRIPTION OF THE PREFERRED EMBODIMENT

Technical solutions adopted in the embodiments of the present invention will be described clearly and completely below in conjunction with the accompanying drawings. It is clear that the embodiments described are only a part of all the embodiments of the present invention. Based on the embodiments below, all other embodiments obtained by those skilled in the art without making creative labor are covered by the protection scope of the present invention.

It should be noted that the terms “first”, “second”, etc., in the specification and claims, as well as in the accompanying drawings, are used to distinguish similar objects and need not be used to describe a particular order or sequence. It should also be understood that the data used may be interchangeable, where appropriate, so that the embodiments described can be implemented in an order other than those illustrated or described herein. In addition, the terms “comprise” and “include”, and any variations thereof, are intended to cover non-exclusive embodiments. For example, a process, method, apparatus, product, or device comprising a series of steps or units is not limited to only those steps or units that are explicitly listed.

Some technical terms described in the present invention will be explained as follows.

Dissipative structure is an ordered structure formed within an open system far from equilibrium through the exchange of matter, energy, and information with the environment. The formation of a dissipative structure is typically accompanied by a dynamic equilibrium between stability and destabilization: the system exhibits local stability during small fluctuations, while destabilization may occur when the system is subjected to external perturbations that exceed a critical point, triggering the generation of a new structure through nonlinear effects. This new structure can utilize resources and environmental conditions more efficiently, thereby maintaining the overall stability of the system. This concept was proposed by the Belgian physical chemist Ilya Prigogine and is primarily used to explain the phenomenon of self-organization under non-equilibrium conditions.

In the prior art, although conventional industry evaluation methods such as SWOT analysis, Porter's five forces analysis, PEST analysis and life cycle analysis provide a framework for industry analysis, the limitations of qualitative analysis make it difficult to accurately reveal the dynamic characteristics of the industry system, not to mention quantifying the nonlinear evolutionary law of the industry system being far from the equilibrium state.

The present invention addresses the shortcomings of conventional methods and introduces the Brusselator model based on dissipative structure theory. With its openness and nonlinear characteristics, the Brusselator model is suitable for portraying the complex interaction logic between capital inputs, resource allocation, production activities, and market feedback in the industry development cycles. The model maps the key productive resources into reactants (external resource inputs), intermediates (internal organizational efficiency of the industry and market feedback), and final products (system outputs and outcomes) by constructing chemical reaction equations. The kinetic differential equations constructed based on this can not only quantitatively analyze the dynamic evolution process of the industry system, but also identify the turning point of the system evolution from a steady state to a destabilized state by calculating the critical conditions. This method effectively addresses the shortcomings of conventional qualitative analysis and provides a reliable technical solution for quantitatively assessing the state of the industry system.

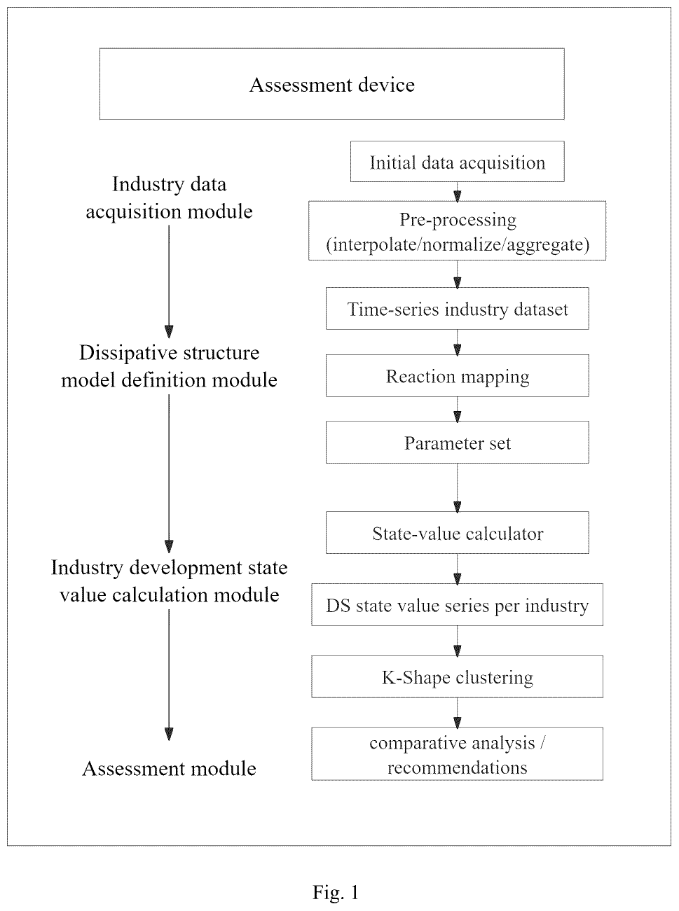

Specifically, as shown in FIG. 1 of the drawings, an industry development state assessment device based on a dissipative structural model is provided, comprising:
an industry data acquisition module for acquiring time-series-based industry data of different industries, wherein the industry data comprises a balance sheet, a profit and loss statement, and a cash flow statement; the cash flow statement comprises inventory data, operating revenues, operating costs, selling expenses, administrative expenses, research and development expenses, and financial expenses;
a dissipative structure model definition module for mapping a nonlinear mutual feedback relationship between industry development core elements according to a Brusselator model and an industry development cycle law, and for obtaining a dissipative structure state function of industry development cycles, wherein the dissipative structure state function is used to characterize development cycle states of the different industries at each time point;
an industry development state value calculation module for sequentially substituting the time-series-based industry data of the different industries into the dissipative structure state function to obtain time-series-based data of industry development states of the different industries; and
an assessment module for clustering the time-series-based data of the industry development states of the different industries to obtain at least two industry collections with similar evolutionary laws, and then comparing and evaluating the industry evolutionary laws of each of the industry collections.

It can be understood that the present invention is primarily based on the assessment of publicly available industry financial data, by identifying different industries and collecting publicly available financial data of representative companies in each industry as the basis for subsequent data processing. Since different companies have different development states, i.e., different developmental time nodes, it is also necessary to establish a correlation relationship between different financial data and the corresponding development time nodes, so as to ensure that different financial data can reflect the reliable industry development stability at the corresponding time nodes. The Brusselator model based on the dissipative structure theory is then combined to define and divide the different financial data, so as to obtain the time-series-based data of the corresponding industry development state of different industries, which in turn facilitates subsequent assessment and analysis, and thus quantitatively describes the state of the developmental evolution of different industries.

Preferably, the industry data acquisition module comprises:
an initial data acquisition unit for acquiring industry initial data of the different industries at different time points; and
a data processing unit for interpolating, normalizing, and summarizing the industry initial data to obtain processed industry data.

That is to say, to ensure the standardization and reliability of data processing, it is necessary to clarify and preprocess the data to obtain industry-level financial data under the same standard. Specifically, the balance sheets, the profit and loss statements, and the cash flow statements of all or representative companies in different industries for each year and quarter should be obtained. The balance sheet reveals the company's financial position, reflecting the company's assets, liabilities, and owner's equity at a specific point in time (e.g., the end of the year or the end of the quarter). The profit and loss statement presents the company's revenues, costs, expenses, and net profits, reflecting its profitability over a specific period (e.g., yearly or quarterly). The cash flow statement reveals the company's efficiency in capital flow and cash management, recording the company's cash inflows and outflows in operating, investing, and financing activities during a specific period (e.g., yearly or quarterly). Then, inventory levels, operating revenues, operating costs, selling expenses, administrative expenses, research and development expenses, financial expenses, and other variables are extracted from the statements. The data for companies included in each industry classification are screened, missing values are eliminated, and statistical interpolation is performed for some of the missing values. The data of companies belonging to the same industry are summarized to obtain the data of the industry as a whole (total revenues, total costs, and so on). The overall indicators of the industry (such as return on assets, profit margin, etc.) are calculated.

A table of key parameters for each industry can be constructed by the above units, facilitating subsequent processing and calculation.

Preferably, the dissipative structural model definition module comprises:
a Brusselator model construction unit for constructing a reaction equation of an industry system evolution based on the Brusselator model, wherein reaction elements of the reaction equation comprise reactants, products, intermediate products, and reaction catalysts;
a reaction element definition unit for determining a calculation formula for each of the reaction elements based on industry characteristics and characteristics of each of the reaction elements; and
a dissipative structure state function construction unit for constructing the dissipative structure state function by characterizing and solving the reaction equation of the industry system evolution according to chemical reaction kinetics.

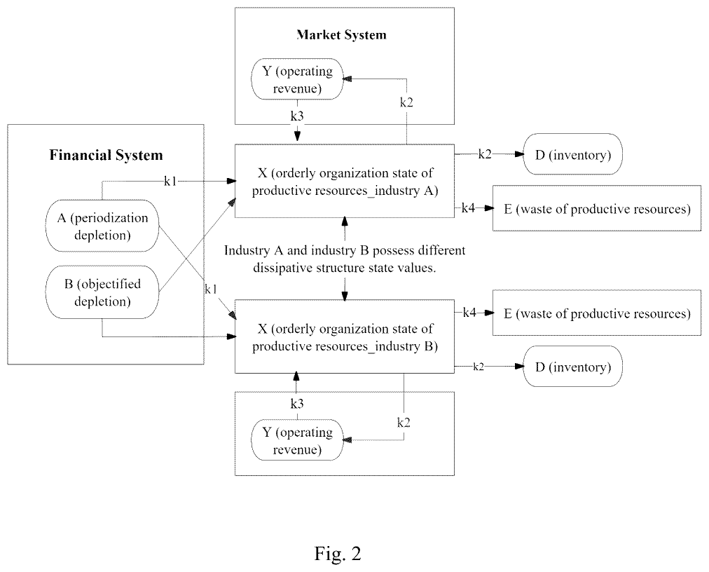

It can be understood that the present invention is based on the Brusselator model as a theoretical foundation. Firstly, the nonlinear mutual feedback relationship between different links is mapped into a chemical reaction equation according to the basic logic of the industry development cycle, as shown in FIG. 2. The reaction equation systematically reveals the evolutionary characteristics of the industry system under open conditions by describing the dynamic feedback process of capital input, resource allocation, production activities, and market sales. Secondly, the reaction equation is transformed into a kinetic differential equation with the intermediate product as the dependent variable, quantitatively describing the dynamic mechanism of the industry development cycle. Lastly, the critical condition function of the system's evolution from the stable state to the destabilized state is revealed by solving the differential equation set.

Specifically, the Brusselator model is an essential model for explaining the formation of dissipative structures. The model uses chemical reaction equations to express the association between key elements in the system and simulate the transformation process of these elements under the action of limited environments or conditions, which provides a quantitative, logical basis for further judging the state evolution of the system and the critical conditions for the formation of dissipative structures. The chemical reaction equations of the Brusselator model are as follows:

$$A {\to }^{{k}_{1}} X \qquad ( 1 )$$

$$B + X {\to }^{{k}_{2}} D + Y \qquad ( 2 )$$

$$Y + 2 X {\to }^{{k}_{3}} 3 X \qquad ( 3 )$$

$$A {\to }^{{k}_{4}} E \qquad ( 4 )$$

wherein A and B are the reactants, D and E are the products, X and Y are the intermediate products, and kᵢ is the reaction catalyst. The chemical reaction described in equations (1)-(4) is that the reactants A and B are converted to the reaction products D and E under the action of the catalyst through the intermediate products X and Y. The reactants A and B are continuously consumed and replenished. The intermediate products X and Y act as both reactants and products during the reaction process, and the autocatalytic effect of X accelerates and promotes the overall reaction process. Reaction equation (1) indicates that under the action of catalyst k₁, the reactant A is converted to the intermediate product X. Reaction equation (2) indicates that under the action of catalyst k₂, the reactant B combines with the intermediate product X to produce the intermediate product Y and the final product D. Reaction equation (3) is an autocatalytic reaction process, which indicates that under the action of catalyst k₃, the intermediate product X interacts with Y to produce more intermediate product X. This equation reflects the system self-enhancement and acceleration of the reaction process. Reaction equation (4) indicates that the intermediate product X is converted to the product E under the action of catalyst k₄.

The Brusselator model is based on the fact that the industry development cycle is an open system that receives capital inputs from the outside world to support the industry's resource allocation and production activities, and through the market, the products and services formed from resource allocation and production are traded to generate revenues to support the industry's operation and expansion of reproduction, which is in line with the logic of the interactions between the substances and the environment that can be combined to generate new substances, and can be characterized by chemical reaction equations.

Therefore, according to the embodiment of the present invention, the Brusselator model is adaptively expressed by mapping the reactants, the intermediate products, and the final products of a chemical reaction as the key elements in the cyclic mechanism of the industry development, and mapping the periodization depletion and the objectified depletion as the reactants A and B, respectively. The capital that the industry system obtains from the external world is mainly used in the form of the periodization depletion and the objectified depletion within the system, so as to support the daily operation and production activities of the industry system.

Periodization depletion is a cost related only to operational activities and not directly to the production process, for a limited period, such as selling, administrative, financial, and research and development costs.

The objectified depletion is a cost that is directly used to produce specific products, such as raw materials and direct labor costs.

The present invention maps the intermediate products X and Y to an orderly organization state of productive resources and operating revenue, respectively, and maps the reactive products D and E to inventory and waste of productive resources, respectively.

The continuous input of the reactants A and B and the output of the products D and E reflect the open character of the industry system.

Then, it is necessary to excavate the correlation and dynamic relationship between the reaction elements, and map the reaction equations of the Brusselator model to the industry development cycle according to the economic logic. Each reaction equation is interconnected to form a complete chain of investment, organization, production, sales, expansion, and internal consumption of the industry system. The reaction equations are as follows:

$$A ( periodization depletion ) {\to }^{{k}_{1}} X ( orderly organization state of productive resources ) ; \qquad ( 5 )$$

$$B ( objectified depletion ) + X ( orderly organization state of productive resources ) {\to }^{{k}_{2}} D ( inventory ) + Y ( operating revenue ) ; \qquad ( 6 )$$

$$Y ( operating revenue ) + 2 X ( orderly organization state of productive resources ) {\to }^{{k}_{3}} 3 X ( industrial expansion ) ; \qquad ( 7 )$$

$$X ( orderly organization state of productive resources ) {\to }^{{k}_{4}} E ( waste of productive resources ) ; \qquad ( 8 )$$

wherein A and B are the reactants, D and E are the products, X and Y are the intermediate products, kᵢ is the reaction catalysts, k₁ denotes an information transfer efficiency, k₂ denotes a capital turnover rate, k₃ denotes a return on investment, and k₄ denotes a system waste rate.

Reaction equation (5) denotes the transformation of capital injection into the orderly organization of industry system elements (X). Reaction equation (6) denotes the production and sales process. Reaction equation (7) denotes the feedback from the market that brings about the autocatalysis of the industry's development cycle and industry expansion. Reaction equation (8) denotes the phenomenon of entropy increase, i.e., the waste of productive resources. These four reaction equations together construct the basic logic of the industry development cycle, wherein external resources enter the system through periodization and objectified depletion, promoting the orderly organization and reproduction of elements, while the system also faces the challenge of entropy increase. Specifically:

Reaction equation (5) indicates how funds are injected into the industry system in the form of the periodization depletion (A) and promote the orderly organization of productive resources (X) under the influence of certain information transfer efficiency (k₁). The periodization depletion (A) specifically comprises administrative expenses, research and development expenses, selling expenses, and financial expenses. The orderly organization of productive resources (X) is embodied in the establishment of management processes, support for technological development, optimization of production organization, broadening of sales channels, and financing, which is the key to supporting the continuous operation of the industry system.

Reaction equation (6) represents the actual production and sales process of the industry. Reaction equation (6) indicates that at a certain level of industry capital turnover rate (k₂), the orderly organizational state of the productive resources (X) and the objectified depletion (B) interact to drive the production and sales activities, leading to the generation of unsold products (D) and operating revenues from sold products (Y). The objectified depletion (B) comprises material costs and labor costs.

Reaction equation (7) represents the expansion of industry organization (X) driven by operating revenues (Y). Specifically, motivated by industry return on investment (k₃), revenue (Y) works with the existing industry factor organization (2X) to generate the expanded-scale structure (3X). This autocatalytic process drives the industry's expansion through the reinvestment of revenue and is the key mechanism for the formation of the dissipative structure.

Reaction equation (8) indicates that the elements of the industry system are not efficiently utilized to generate products or services after orderly organization (X), but are wasted (E) due to organizational internal dissipation, idle resources, or mismanagement, such as product development failure, redundant inputs, or inefficient operations. This waste reflects the phenomenon of entropy increase in the system, which is similar to the unavoidable loss that occurs during the process of energy conversion. In the equation, k₄ represents the system waste rate.

The formulas for the elements of the reaction equation are further defined. In order to reflect the reactant intensity characteristics in the chemical reaction equation and to unify the order of magnitude of each element, the present invention adopts a relative percentage approach for characterization, which helps to comprehensively quantify the dynamic characteristics of resource allocation in the industry system, wherein the periodization depletion is expressed as:

$$periodization depletion ( A ) = \frac{\begin{matrix}administrative expenses + \\ research and development expenses + \\ selling expenses + financial expenses\end{matrix}}{total operating costs} ; \qquad ( 9 )$$

the objectified depletion is expressed as:

$$objectified depletion ( B ) = \frac{operating costs}{total operating costs} ; \qquad ( 10 )$$

the inventory level is expressed as:

$$inventory level ( D ) = \frac{inventory}{total operating costs} ; \qquad ( 11 )$$

the operating revenue level is expressed as:

$$operating revenue level ( Y ) = \frac{operating revenue}{total operating costs} ; \qquad ( 12 )$$

the information transfer efficiency is expressed as:

$$( 13 )$$

$$information transfer efficiency ( {k}_{1} ) = \frac{\begin{matrix}Current Period Operating Revenue / \\ Prior Period Operating Revenue\end{matrix}}{\begin{matrix}Current Period Depletion / \\ Prior Period Depletion\end{matrix}} ;$$

the capital turnover rate is expressed as:

$$capital turnover rate ( {k}_{2} ) = \frac{operating revenue}{current assets} ; \qquad ( 14 )$$

the return on investment is expressed as:

$$return on investment ( {k}_{3} ) = \frac{operating profit increment}{total operating costs} ; \qquad ( 15 )$$

the system waste rate is expressed as:

$$\qquad ( 16 )$$

$$system waste rate ( {k}_{4} ) = \frac{\begin{matrix}inventory + administrative expenses + \\ financial expenses - net profit\end{matrix}}{period depletion + objectified depletion} ;$$

Change rates of the key elements are derived based on the reaction equations. According to the principle of chemical reaction kinetics, the present invention chooses to construct differential equations for the intermediate products (X, Y) because these intermediate products are typically autocatalytic in the Brusselator model, which are key factors driving the system to self-enhancement or decline. Their dynamic changes can reflect the evolutionary path of the system as it approaches the critical point of instability, which is the core of stability analysis. In addition, the change rates of the intermediates are the earliest indication of changes in system stability. By modeling the intermediates, the complex behavior of a system as it moves away from equilibrium can be captured. In the industry development cycle, reactant intensity can be considered as a share of resources or factors.

Specifically, A and B represent the share of the periodization and objectified depletions in total operating costs, respectively, rather than a single variable. This perspective enables a comprehensive understanding of the dynamic characteristics of resource allocation within the industry system. By establishing differential equations for the dynamic change rates of the intermediates, a clearer view can be obtained of how a feedback loop in the system affects the overall evolution. The evolutionary dynamics equation set is as follows:

$$\{ \begin{matrix}\frac{dX}{dt} = {k}_{1} A - {k}_{2} BX + {k}_{3} {X}^{2} Y - {k}_{4} X \\ \frac{dY}{dt} = {k}_{2} BK - {k}_{3} {X}^{2} Y\end{matrix} \qquad ( 17 )$$

wherein A denotes the periodization depletion, B denotes the objectified depletion, X denotes the orderly organization state of productive resources, D denotes the unsold output products (inventory), Y denotes the operating revenue, and E denotes the waste of productive resources. k serves to portray the external conditions (or environmental conditions) under which variables undergo qualitative changes, wherein k₁ is the factor that affects the rate of orderly organization of the industry, which can be expressed in terms of information transfer efficiency, affected by digital transformation of the industry, corporate culture, etc. k₂ is the capital turnover rate of the industry. k₃ is the return on investment (ROI) of the industry. k₄ is the influence rate for the industry organization moving from orderly to disintegrated under natural conditions, which can be expressed in terms of the rate of internal consumption of the organization or the rate of system waste.

Transformations of parameters and derivation of equations are carried out, thereby solving the differential equations to identify the instability point of the system, wherein

$$x = \sqrt{\frac{{k}_{3}}{{k}_{4}}} X , y = \sqrt{\frac{{k}_{3}}{{k}_{4}}} Y \qquad ( 18 )$$

$$a = \sqrt{\frac{{k}_{1}^{2} {k}_{3}}{{k}_{4}^{3}}} A , b = \frac{{k}_{2}}{{k}_{4}} B , τ = {k}_{4} t \qquad ( 19 )$$

At this point equation (17) is transformed into the following form:

$$\{ \begin{matrix}\frac{dx}{d τ} = a - ( b + 1 ) x + {x}^{2} y \\ \frac{dy}{d τ} = bx ‐ {x}^{2} y\end{matrix} \qquad ( 20 )$$

Equation (20) is solved to obtain the stability equation as shown in equation (21):

$$\{ \begin{matrix}\frac{du}{d τ} = ( b - 1 ) u + {a}^{2} v + \frac{{bu}^{2}}{a} + 2 auv + {u}^{2} v \\ \frac{dv}{d τ} = - bu - {a}^{2} v - \frac{{bu}^{2}}{a} - 2 auv - {u}^{2} v\end{matrix} \qquad ( 21 )$$

A linear approximation of equation (21) is taken as follows:

$$\{ \begin{matrix}\frac{d u}{d τ} = ( b - 1 ) u + {a}^{2} v \\ \frac{dv}{d τ} = - bu - {a}^{2} v\end{matrix} \qquad ( 22 )$$

It is determined whether there is a nonzero solution to equation (22), and set an eigenvalue of the stability equation (22) to λ, then the condition for equation (22) to have a nonzero solution is:

$$\vert \begin{matrix}( b & - 1 ) - λ & {a}^{2} \\ & - b & - {a}^{2} - λ\end{matrix} \vert = 0$$

The characteristic equation is:

$${λ}^{2} + ( {a}^{2} + 1 - b ) λ + {a}^{2} = 0 \qquad ( 23 )$$

Since a>0, there is no zero solution for λ in the characteristic equation, and it can be judged that equation (22) must have a nonzero solution. The stability of the nonzero solution is determined below. In the study of system stability, the real part of the eigenvalue can be used to determine whether the system will reach the destabilization condition. Only when the eigenroot has a negative real part will the system reach the destabilization condition.

Equation (23) is analyzed below by setting a stability parameter ω=b−1−a²,

$${λ}_{1 , 2} = \frac{b - 1 - {a}^{2} \pm \sqrt{{( {a}^{2} + 1 - b )}^{2} - 4 {a}^{2}}}{2} = \frac{1}{2} ( ω \pm \sqrt{{ω}^{2} - 4 {a}^{2}} )$$

By discussing the solution of the characteristic equations and performing the stability analysis, determination condition equation of the industry system dissipative structure can be derived.

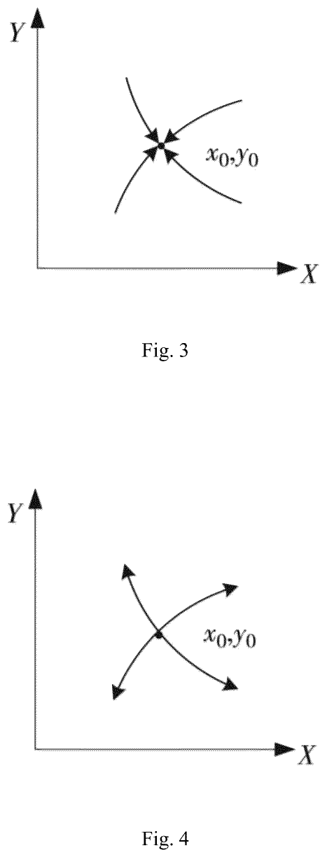

(1) When ω<0 and ω²>4a², λ_{1,2} are both negative real roots, and the system is always stable under large perturbations. Therefore, the stationary point (x₀, y₀) is a stable node. Referring to FIG. 3, the horizontal axis X represents the orderly organization of productive resources, reflecting the internal resource allocation and synergistic efficiency of the industry system. The vertical axis Y indicates the business revenue level, which is a direct reflection of the industry system's response to external market demand. The two together constitute the state space of the industry system, and the phase diagram shows how the system evolves and tends to be stable or destabilized near the point (x₀, y₀).

(2) When ω>0 and ω²>4a², λ_{1,2} are both positive real roots, and any perturbation will cause the system to deviate from the stationary point (x₀, y₀), thus away from equilibrium, so the stationary point is an unstable node, as shown in FIG. 4.

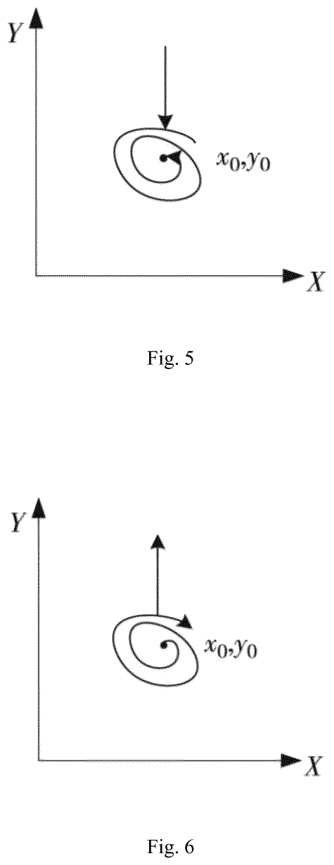

(3) When ω<0 and ω²<4a², λ_{1,2} are conjugated complex roots with negative real parts, and the incremental convergence is close to 0 near the stationary point (x₀, y₀), so the stationary point is a stable focus, as shown in FIG. 5.

(4) When ω>0 and ω²<4a², λ_{1,2} are conjugated complex roots with positive real parts. As time goes by, u and v also become larger. The system is then destabilized and maintains vibration within a specific range, ultimately generating a limit ring centered on the stationary point. Consequently, the fixed state point is an unstable focus, as shown in FIG. 6.

(5) When ω=0, there is an imaginary root, so the stationary point is a stable center, and the system is in a critical state.

Therefore, when ω<0, it means that the industry system is in a stable state, which is a low-efficiency disordered structure. When ω>0, the industry system is destabilized and evolves into a more advanced ordered dissipative structure. If

$$a = \sqrt{\frac{{k}_{1}^{2} {k}_{3}}{{k}_{4}^{3}}} A , b = \frac{{k}_{2}}{{k}_{4}} B , ω = b - 1 - {a}^{2} > 0 ,$$

the eigenvalue has no negative real part, and the industry system is in an instability state, forming a dissipative structure. If ω=b−1−a² <0, the eigenvalue has a negative real part, and the industry system is stable, forming no dissipative structure. Therefore, the industry system dissipative structure determination conditions are shown in equation (24):

$$( 24 )$$

$${k}_{2} {k}_{4}^{2} B - ( {k}_{4}^{3} + {k}_{1}^{2} {k}_{3} {A}^{2} ) \{ \begin{matrix}> 0 , & unstable , forming a dissipative structure \\ = 0 , & at a critical juncture of being stable or unstable \\ < 0 , & stable with no dissipative structure\end{matrix}$$

According to the present invention, the dissipative structure state of the industrial system is calculated using nonlinear system stability analysis, and thus can also be regarded as a stability state of the industrial system. The value of the dissipative structure state is calculated by:

$$IS = {k}_{2} {k}_{4}^{2} B - ( {k}_{4}^{3} + {k}_{1}^{2} {k}_{3} {A}^{2} ) \qquad ( 25 )$$

The destabilization of the industry system reflects an imbalance, which may be evident in the disparity between supply and demand, the competition among different enterprises in the industry, and the impact of new technologies or products on the market. In a destabilized environment, an industrial organization evolves into a dissipative structure, indicating that the industry system develops an orderliness to cope with this imbalance. A non-dissipative structure implies relative stability and equilibrium; an economic organization with a dissipative structure has not yet evolved. It also implies that there is a lack of a strongly ordered economic organization in the industry to change the equilibrium or stable state within the system. The dissipative structure state value represents the distance between the current state of the industry system and a destabilized state, reflecting the comprehensive degree of imbalance within the system. Only when this imbalance exceeds a certain level can the industry system further evolve towards a more orderly economic organization, i.e., a dissipative structure.

The dissipative structure state value is the distance at which the industry development cycle evolves into a dissipative structure. A positive value of this distance reflects the emergence of an unstable state of the industry system, which in turn will exhibit more complex behavioral patterns. In an economic system, the destabilization of the industry system can be attributed to external shocks, including changes in the market environment, technological innovations, and policy shifts. These shocks can cause the industry system to deviate from its original equilibrium state, leading to the formation of new industry structures and innovations through self-organization. When a new technology is introduced, it may exacerbate the imbalance within the industry system and lead to the destabilization of that industry. Traditional industry economic units may face obsolescence, while emerging industry units may spontaneously form and grow rapidly. This process is similar to the formation of new structures after system destabilization in the Brusselator model. Sudden changes in market demand or changes in the competitive landscape can also lead to the destabilization of the industry system.

Companies need to self-organize and adapt to the new market environment by innovating and adjusting their strategies. Therefore, it is possible to determine the current stabilization state of the industry based on the dissipative structure state value, and then implement appropriate coping strategies.

If this distance is negative, it means that the industry system is relatively stable at that time, corresponding to a non-dissipative structure. This means that the system is at or near equilibrium, with no apparent self-organization or complex dynamic behavior. Industry systems with non-dissipative structures generally exhibit stability, predictability, and low complexity. Being stable means that small perturbations do not cause the system to deviate from its equilibrium state, and the system can quickly return to its original state.

Preferably, according to the embodiment of the present invention, the assessment module comprises:
a standardization unit for standardizing the time-series-based data of the industry development states of the different industries, and obtaining a processed time-series-based data of the industry development states, which is:

$${t}_{ik}^{′} = \frac{{t}_{ik} - {\overline{t}}_{i}}{{σ}_{i}} , k = 1 , 2 , … , m ;$$

wherein t̅ᵢ is a mean value of a series Tᵢ, σᵢ is a standard deviation thereof, and

$${t}_{ik}^{′}$$

is a k-th point of a standardized time series Tᵢ;
a clustering unit for utilizing a K-Shape clustering algorithm to classify the processed time-series-based data of the industry development states to obtain at least one industry collection with similar evolutionary laws; and
an assessment unit for assessing the industry evolution states based on the time-series-based data in each of the industry collection to determine an adjustment strategy for industry development.

That is to say, after obtaining the time-series-based data (i.e., time series) of each industry, the time series of dissipative structure state values are analyzed with the K-Shape clustering analysis method, wherein the industries with similar evolutionary patterns are categorized and contrasted to reveal different industry stability characteristics.

Specifically, the clustering unit is configured to:
randomly select a plurality of the time-series-based data as initial group centers;
calculate similarities between each of the time-series-based data and each of the initial group centers, and assign each of the time-series-based data to one of the series groups in which the initial group center with the highest similarity is located; and
re-determine group centers of each of the series groups and re-assign the series groups based on the similarities until a convergence condition is satisfied, so as to obtain a plurality of target series groups; wherein each of the target series groups has at least one industry collection; the convergence condition is: the group centers of the series groups are no longer changed, or a pre-determined maximum number of iterations is reached.

Exemplarily, the K-Shape clustering method is used to group the time series by shape similarity thereof, and dissipative structural state value time series of each industry is normalized to eliminate the effects of magnitude and offset, so that the mean is 0 and the variance is 1:

$${t}_{i k}^{l} = \frac{{t}_{i k} - {\overline{t}}_{i}}{{σ}_{i}} , k = 1 , 2 , … , m \qquad ( 26 )$$

wherein t̅ᵢ is a mean value of a series Tᵢ, σᵢ is a standard deviation thereof, and

$${t}_{ik}^{′}$$

is a k-th point of a standardized time series Tᵢ. This normalization ensures that clustering is based on series shape rather than magnitude.

Multiple time series are randomly selected as the initial group centers {C₁, C₂, . . . , Cₖ}, and each group center is a normalized time series. Shape similarity each time series Tᵢ and each group center Cⱼ is calculated, which is measured with normalized cross-correlation (NCC):

$$NCC ( {T}_{i} , {C}_{j} ) = {max}_{τ} \frac{{\sum }_{k = 1}^{m} {t}_{ik}^{′} \cdot {c}_{j ( k + τ )}^{′}}{\sqrt{{\sum }_{k = 1}^{m} {( {t}_{ik}^{′} )}^{2}} \cdot \sqrt{{\sum }_{k = 1}^{m} {( {c}_{j ( k + τ )}^{′} )}^{2}}} \qquad ( 27 )$$

wherein τ is an offset to ensure that the series are aligned within a certain range. The maximum correlation value is taken as the similarity.

Each time series Tᵢ is assigned to a group Cⱼ with the largest shape similarity:

$${j}^{*} = arg {max}_{j} NCC ( {T}_{i} , {C}_{j} ) \qquad ( 28 )$$

wherein Tᵢ denotes the dissipative structure state value time series of the i-th industry, Cⱼ denotes the center time series of the j-th group, and j* denotes the target group number (i.e., the group with the most significant similarity) to which the series Tᵢ is assigned.

According to the current group assignment, the center of each group Cⱼ is recalculated. For the group Cⱼ, all series currently assigned to the group {Tᵢ|Tᵢ∈Cⱼ} are extracted. Mean values of all time series in the group are calculated point by point to generate a new group center, and an update formula is:

$${c}_{jk} = \frac{1}{\vert {C}_{j} \vert} {\sum }_{{T}_{i} ∈ {C}_{j}} {t}_{ik}^{′} , k = 1 , 2 , … , m \qquad ( 29 )$$

wherein Cⱼₖ denotes the k-th point of the group center Cⱼ, |Cⱼ| is the number of time series in the group

$${C}_{j} \cdot {C}_{j}^{′} = \{ {c}_{j 1} , {c}_{j 2} , … , {c}_{jm} \}$$

is the new group center.

The above steps are executed until either of the following conditions is satisfied: (1) the group center does not change anymore (i.e., the group division is stable); (2) the pre-determined maximum number of iterations is reached. k groups are output, each of which contains time series of similar shapes, i.e., industries with similar characteristics of steady state evolution, thereby further studying the similarities and differences in the steady state evolution of each industry in conjunction with the specific characteristics of each industry, so as to provide a reference for the formulation of industry policies and the optimization of resource allocation.

The present invention has the following beneficial effects:
1. Revealing the stability and evolutionary law of industry system development cycles from the perspective of dissipative structure. The present invention breaks through the limitations of conventional methods and comprehensively portrays the dynamic characteristics of the industry system development cycles from the perspective of dissipative structure. The industry system development cycle is not only nonlinear but also open, relying on the continuous exchange of external capital and resource inputs and outputs. Conventional quantitative or qualitative methods cannot completely describe this complex process; however, through the theory of dissipative structures in complex systems, the present invention provides a quantitative portrayal and explanation of the stability of the industry system development cycle.
2. Focusing on the innovative application of the Brusselator model, revealing the internal mechanism of the industry system. Based on the Brusselator model, the present invention utilizes the chemical reaction equation to simulate the dynamic interaction process of the industry system. The present invention not only reveals the logical relationship between capital input, resource allocation, production activities, and market feedback of the industry system, but also makes use of kinetic differential equations to accurately model and quantitatively analyze the dynamic evolution process of these elements. The present invention not only clarifies the nonlinear feedback mechanism between the elements within the industry system, but also digs out the dynamic evolution mechanism of the industry system when it is far from the equilibrium state, providing a scientific explanation for the formation conditions of the dissipative structure.
3. Breaking through the limitations of conventional assessment methods by combining quantitative analysis and comparative analysis methods. By calculating and comparing the dissipative structure state values, the present invention can reveal the evolutionary law and suitability of different industries in transitioning between stability and dissipative states, and provide a deep analysis of the advantages and disadvantages of dissipative structures for the development of various industries. By calculating the dissipative structure state of the industry system, the current evolution of the industry can be investigated.

In practice, studying the relationship between the intrinsic attributes and characteristics of different industries and their stability, combined with the calculation and comparative analysis of dissipative structure state values, can not only identify the direction of stability evolution and destabilizing conditions of the industry, but also reveal the suitability of the dissipative structure for the development of the industry. For example, the agricultural industry is more suitable to operate in a lower dissipation state to maintain the stability of seasonal production, while a high dissipation state may lead to resource wastage and market imbalance. In contrast, technology industries such as the semiconductor industry require a certain degree of dissipation to drive technological innovations through external shocks and to realize the reconfiguration of the production model. It can be seen that through comparative analysis and quantitative assessment, the optimization of resource allocation, policy formulation, and development strategies of different industries can be scientifically guided, clarifying the positive or negative effects of the dissipative structure on the development dynamics of different industries, and providing directional value for the development of industries.

According to another embodiment of the present specification, an assessment apparatus, comprising: a memory and a processor, wherein a computer program is stored on the memory and is runnable on the processor; wherein the assessment apparatus further comprises the industry development state assessment device as mentioned above.

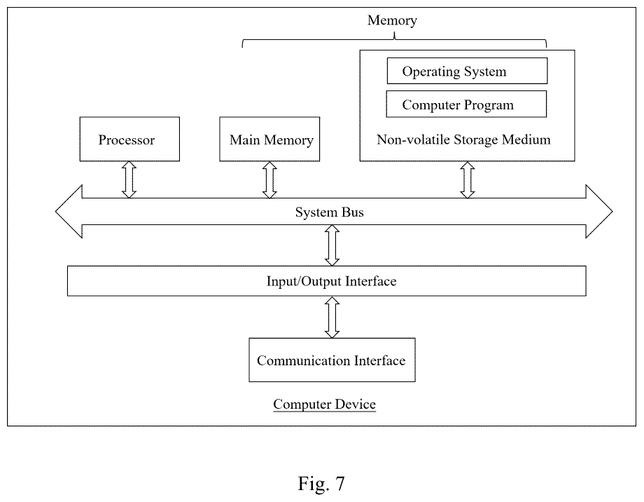

According to the embodiment, the computer apparatus may be the above-mentioned assessment device, whose internal structure is shown in FIG. 7. This computer device comprises a processor, a memory and a network interface connected via a system bus, wherein the processor of the computer device is used to provide computing and control capabilities; the memory of the computer device comprises a non-volatile storage medium and an internal memory; the non-volatile storage medium stores an operating system and a computer program; the internal memory provides an environment for running the operating system and the computer program in the non- volatile storage medium; the network interface of the computer device communicates with an external terminal via a network connection.

It will be appreciated to those skilled in the art that the structure illustrated in FIG. 7 is exemplary only and is not intended to be limiting. The specific computer device may comprise more or fewer components than those shown in the drawings, or may combine some of the components, or may have a different arrangement of components.

In one embodiment, a computer device is provided, comprising a memory and a processor, wherein the memory stores a computer program, and the processor executes the computer program to implement the processes embodied above.

In another embodiment, a computer-readable storage medium is provided, having a computer program stored thereon, wherein the computer program realizes the processes embodied when executed by a processor.

In yet another embodiment, a computer program product is provided, comprising a computer program that realizes the processes embodied above when executed by a processor.

A person of ordinary skill in the art may understand that it is possible to realize all or part of the processes embodied above by means of a computer program which instructs the relevant hardware to accomplish the same, and that a computer program may be stored in a non-volatile computer-readable storage medium, which, when executed, may comprise the processes embodied above. Among other things, any reference to a memory, database, or other medium used in the embodiments of the present invention may comprise at least one of non-volatile and volatile memories. Non-volatile memories may comprise Read-Only Memory (ROM), magnetic tape, floppy disk, flash memory, optical memory, high-density embedded non-volatile memories, Resistance-Resistive Memory (ReRAM), Magnetoresistive Random Access Memory (MRAM), Ferroelectric Random Access Memory (FRAM), Phase Change Memory (PCM), graphene memory, and so on. The volatile memory may comprise Random Access Memory (RAM) or an external cache memory, and the like. Exemplarily, the RAM may be in various forms, such as Static Random Access Memory (SRAM) or Dynamic Random Access Memory (DRAM), and the like. The databases involved in the embodiments of the present invention may comprise at least one of a relational database and a non-relational database. The non-relational database may comprise, but not be limited to, a blockchain-based distributed database and the like. The processor involved in the embodiments may be a general-purpose processor, a central processing unit, a graphics processor, a digital signal processor, a programmable logic unit, a data processing logic unit based on quantum computing, and the like.

It should also be understood that in the embodiments, the term “and/or” is merely a description of an association relationship of associated objects, indicating that three conditions may exist. For example, A and/or B can mean: A alone, both A and B, and B alone. In addition, the character “/” herein generally indicates that the associated objects are in an “or” relationship.

A person of ordinary skill in the art may realize that the units and algorithmic steps described above can be realized by electronic hardware, computer software, or a combination of both, and in order to clearly illustrate the interchangeability of the hardware and the software, the compositions and the steps have been described in the foregoing description in general terms according to the functions. Whether these functions are performed in hardware or software depends on the particular application and design constraints of the technical solution. A skilled person may use different methods to implement the described functions for each specific application, but such implementations should not be considered outside the claimed scope of the present invention.

It is clear to those skilled in the field that, for the sake of convenience and brevity of description, the specific working processes of the above-described systems, apparatuses, and units can be referred to the corresponding processes in the foregoing embodiments, which will not be repeated herein.

In the embodiments of the present invention, it should be understood that the systems, devices, and methods disclosed may be realized in other ways. For example, the devices embodied above are merely schematic; the division of the units described is merely a logical functional division and may be implemented in other ways; a plurality of units or components may be combined or may be integrated into another system, or some features may be ignored or not implemented. Furthermore, mutual coupling or direct coupling or communication connection between each other shown or discussed may be indirect coupling or communication connection through some interface, device, or unit, or may be connected electrically, mechanically, or in some other form.

The units illustrated as separated components may or may not be physically separated, and components shown as units may or may not be physical units, i.e., they may be located in a single place, or they may also be distributed over a plurality of network units. Some or all of these units may be selected to fulfill the purpose of the embodiments according to actual needs.

The preferred embodiments above illustrate the principles and implementation of the present invention, which are only used to help understand the method of the present invention and its core ideas. At the same time, for those skilled in the art, based on these ideas, the specific implementation and application may be different. In summary, the contents above should not be interpreted as a limitation of the present invention.

What is claimed is:

1. An industry development state assessment device based on a dissipative structural model, comprising:
an industry data acquisition module for acquiring time-series-based industry data of different industries, wherein the industry data comprises a balance sheet, a profit and loss statement, and a cash flow statement; the cash flow statement comprises inventory data, operating revenues, operating costs, selling expenses, administrative expenses, research and development expenses, and financial expenses;
a dissipative structure model definition module for mapping a nonlinear mutual feedback relationship between industry development core elements according to a Brusselator model and an industry development cycle law, and for obtaining a dissipative structure state function of industry development cycles, wherein the dissipative structure state function is used to characterize development cycle states of the different industries at each time point;
an industry development state value calculation module for sequentially substituting the time-series-based industry data of the different industries into the dissipative structure state function to obtain time-series-based data of industry development states of the different industries; and
an assessment module for clustering the time-series-based data of the industry development states of the different industries to obtain at least two industry collections with similar evolutionary laws, and then comparing and evaluating the industry evolutionary laws of each of the industry collections.

2. The industry development state assessment device, as recited in claim 1, wherein the industry data acquisition module comprises:
an initial data acquisition unit for acquiring industry initial data of the different industries at different time points; and
a data processing unit for interpolating, normalizing, and summarizing the industry initial data to obtain processed industry data.

3. The industry development state assessment device, as recited in claim 1, wherein the dissipative structural model definition module comprises:
a Brusselator model construction unit for constructing a reaction equation of an industry system evolution based on the Brusselator model, wherein reaction elements of the reaction equation comprise reactants, products, intermediate products, and reaction catalysts;
a reaction element definition unit for determining a calculation formula for each of the reaction elements based on industry characteristics and characteristics of each of the reaction elements; and
a dissipative structure state function construction unit for constructing the dissipative structure state function by characterizing and solving the reaction equation of the industry system evolution according to chemical reaction kinetics.

4. The industry development state assessment device, as recited in claim 3, wherein the reaction equation is expressed as:
$$A ( periodization depletion ) {\to }^{{k}_{1}} X ( orderly organization state of productive resources ) ;$$
$$B ( objectified depletion ) + X ( orderly organization state of productive resources ) {\to }^{{k}_{2}} D ( inventory ) + Y ( operating revenue ) ;$$
$$Y ( operating revenue ) + 2 X ( orderly organization state of productive resources ) {\to }^{{k}_{3}} 3 X ( industrial expansion ) ;$$
$$X ( orderly organization state of productive resources ) {\to }^{{k}_{4}} X ( orderly organization state of productive resources ) ;$$
wherein A and B are the reactants, D and E are the products, X and Y are the intermediate products, kᵢ is the reaction catalysts, k₁ denotes an information transfer efficiency, k₂ denotes a capital turnover rate, k₃ denotes a return on investment, and k₄ denotes a system waste rate.

5. The industry development state assessment device. as recited in claim 4. wherein
the periodization depletion is expressed as:
$$periodization depletion ( A ) = \frac{\begin{matrix}administrative expenses + research and development \\ expenses + selling expenses + financial expenses\end{matrix}}{total operating costs} ;$$
the objectified depletion is expressed as:
$$objectified depletion ( B ) = \frac{operating costs}{total operating costs} ;$$
the inventory level is expressed as:
$$inventory level ( D ) = \frac{inventory}{total operating costs} ;$$
the operating revenue level is expressed as:
$$operating revenue level ( Y ) = \frac{operating revenue}{total operating costs} ;$$
the information transfer efficiency is expressed as:
$$information transfer efficiency ( {k}_{1} ) = \frac{\begin{matrix}Current Period Operating Revenue / \\ Prior Period Operating Revenue\end{matrix}}{Current Period Depletion / Prior Period Depletion} ;$$
the capital turnover rate is expressed as:
$$capital turnover rate ( {k}_{2} ) = \frac{operating revenue}{current assets} ;$$
the return on investment is expressed as:
$$return on investment ( {k}_{3} ) = \frac{operating profit increment}{total operating costs} ;$$
the system waste rate is expressed as:
$$system waste rate ( {k}_{4} ) = \frac{\begin{matrix}inventory + administrative expenses + \\ financial expenses - net profit\end{matrix}}{periodization depletion + objectified depletion} .$$

6. The industry development state assessment device, as recited in claim 5, wherein the dissipative structure state function is obtained as follows:
based on the chemical reaction kinetics, the intermediate products in the reaction equation of the industry system evolution are differentiated to obtain a differential equation set:
$$\{ \begin{matrix}\frac{dX}{dt} = {k}_{1} A - {k}_{2} BX + {k}_{3} {X}^{2} Y - {k}_{4} X \\ \frac{dY}{dt} = {k}_{2} BX - {k}_{3} {X}^{2} Y\end{matrix} ;$$
the differential equation set is then transformed to obtain a transformed equation set:
$$\{ \begin{matrix}\frac{dx}{d τ} = a - ( b + 1 ) x + {x}^{2} y \\ \frac{dy}{d τ} = bx - {x}^{2} y\end{matrix} ;$$
wherein
$$x = \sqrt{\frac{{k}_{3}}{{k}_{4}}} X , y = \sqrt{\frac{{k}_{3}}{{k}_{4}}} Y ;$$
$$a = \sqrt{\frac{{k}_{1}^{2} {k}_{3}}{{k}_{4}^{3}}} A , b = \frac{{k}_{2}}{{k}_{4}} B , τ = {k}_{4} t ;$$
then stability analysis is performed on the transformed equation set to determine a characteristic equation:
$${λ}^{2} + ( {a}^{2} + 1 - b ) λ + {a}^{2} = 0 ;$$
wherein λ is an eigenvalue;
the dissipative structure state function is determined based on a real part of the eigenvalue in combination with a stability equation:
$$IS = {k}_{2} {k}_{4}^{2} B - ( {k}_{4}^{3} + {k}_{1}^{2} {k}_{3} {A}^{2} ) ,$$
wherein IS is an industry's dissipative structure state value,
when IS is greater than zero, the industry development cycle is unstable, forming a dissipative structure;
when IS is equal to zero, the industry development cycle is at a critical juncture of being stable or unstable; and
when IS is less than zero, the industry development cycle is stable and non-dissipative.

7. The industry development state assessment device, as recited in claim 1, wherein the assessment module comprises:
a standardization unit for standardizing the time-series-based data of the industry development states of the different industries, and obtaining a processed time-series-based data of the industry development states, which is:
$${t}_{i k}^{′} = \frac{{t}_{i k} - {\overline{t}}_{i}}{{σ}_{i}} , k = 1 , 2 , … , m ;$$
wherein t̅ᵢ is a mean value of a series Tᵢ, σᵢ is a standard deviation thereof, and
$${t}_{i k}^{′}$$
is a k-th point of a standardized time series Tᵢ;
a clustering unit for utilizing a K-Shape clustering algorithm to classify the processed time-series-based data of the industry development states to obtain at least one industry collection with similar evolutionary laws; and
an assessment unit for assessing the industry evolution states based on the time-series-based data in each of the industry collection to determine an adjustment strategy for industry development.

8. The industry development state assessment device, as recited in claim 7, wherein the clustering unit is configured to:
randomly select a plurality of the time-series-based data as initial group centers;
calculate similarities between each of the time-series-based data and each of the initial group centers, and assign each of the time-series-based data to one of the series groups in which the initial group center with the highest similarity is located; and
re-determine group centers of each of the series groups and re-assign the series groups based on the similarities until a convergence condition is satisfied, so as to obtain a plurality of target series groups; wherein each of the target series groups has at least one industry collection; the convergence condition is: the group centers of the series groups are no longer changed, or a pre-determined maximum number of iterations is reached.

9. The industry development state assessment device, as recited in claim 8, wherein the similarities between each of the time-series-based data and each of the initial group centers are calculated as:
$$NCC ( {T}_{i} , {C}_{j} ) = {max}_{τ} \frac{{\sum }_{k = 1}^{m} {t}_{i k}^{′} \cdot {c}_{j ( k + τ )}^{′}}{\sqrt{{\sum }_{k = 1}^{m} {( {t}_{i k}^{′} )}^{2}} \cdot \sqrt{{\sum }_{k = 1}^{m} {( {c}_{j ( k + τ )}^{′} )}^{2}}} ;$$
wherein NCC(Tᵢ, Cⱼ) is a similarity between i-th time-series-based data and a j-th initial group center, λ is an offset,
$${t}_{i k}^{′}$$
is a k-th point of the i-th time-series-based data Tᵢ, and
$${c}_{j ( k + τ )}^{′}$$
is a k-th point of the j-th initial group center after offset processing.

10. An assessment apparatus, comprising: a memory and a processor, wherein a computer program is stored on the memory and is runnable on the processor; wherein the assessment apparatus further comprises the industry development state assessment device as recited in claim 1.
